(19) United States
(12) Patent Application Publication
(10) Pub. No.: US 2009/0269482 A1
(43) Pub. Date: Oct. 29, 2009

(54) LAYERED SECURITY MATERIAL AND METHOD OF MANUFACTURING SUCH

(75) Inventor: Jens REMMER, Rauma (FI)

Correspondence Address: NIXON & VANDERHYE, PC, 901 NORTH GLEBE ROAD, 11TH FLOOR, ARLINGTON, VA, 22203, US

(73) Assignees: AHLSTROM KAUTTUA OY, Kauttua (FI); AHLSTROM CORPORATION, Helsinki (FI)

(21) Appl. No.: 12/434,373

(22) Filed: May 1, 2009

Related U.S. Application Data
(62) Division of application No. 11/628,716, filed on Dec. 7, 2006.

(30) Foreign Application Priority Data
Jun. 11, 2004 (FI) 20040806
Jun. 11, 2004 (FI) 20040807

(51) Int. Cl. B41M 3/14

(52) U.S. Cl. 427/7

(57) ABSTRACT

The present invention relates to a layered material such as paper, cardboard, or nonwoven web having a printable surface for text or graphics, composed of a base web (1) and a luminescing coating layer containing identification agent sensitive to UV light or similar, a so-called identification layer (2). Applied on the base web (1), there is at least one identification layer (2) the surface profile of which conforms to the natural formation of the base web (1) and the surface profile of the other coating layers possibly disposed on top of the base web in such a way that the identification layer (2) is at the areas (21) corresponding to the ridges of the base layer (1) thinner than that at the areas (22) corresponding to the valleys of the base layer (1); and the identification layer (2) substantially and advantageously covering the entire underlying surface; and the identification layer (2) having due to the alterations in the thickness of the coating layer, non-continuous intensity when reacting to UV light or similar, causing a cloud-like appearance. The layered material may also contain other coating layers, such as a contrast layer (3) and/or depth layers (4, 5). The present invention also relates to a method of manufacturing such a layered material.

This application is a divisional of commonly owned copending U.S. application Ser. No. 11/628,716 filed on Dec. 7, 2006, which is the national phase application under 35 USC §371 of PCT/FI2005/050208, filed Jun. 10 2005 which designated the U.S. and claims benefit of FI 20040806 and FI 20040807, dated Jun. 11, 2004 and Jun. 11, 2004, respectively, the entire content of which is hereby incorporated by reference.

The present invention relates, in accordance with the preamble of claim 1, to a layered material such as a paper, cardboard, or nonwoven web having a printable surface for text or graphics, composed of a base web and a luminescing coating layer containing identification agent reacting to UV light or similar. The present invention also relates to a manufacturing method of a layered web-like material in accordance with claim 16.

It has become more and more important to make sure that a product of a certain manufacturer is manufactured, delivered or owned by exactly the manufacturer the purchasers of the product assume based on the data markings on the package or on the product itself or based on what they are told.

This authenticity checking is, of course, best known from the fight against the spread of so-called pirate products, or other product and document counterfeits. If the product package itself can be tested in a simple and reliable way and it can be ensured to be genuine, the authenticity checking of the products for example in the customs check, stock purchases and conventional shops becomes significantly easier. The authenticity checking of the packages is, of course, a part of the process, which aims at ensuring that also the contents of the product package are genuine. The same techniques that are used for the authenticity checking of the origin of the packages can be used with the authenticity markings of the product itself.

The counterfeiting of different valuable papers, be they entrance tickets or other printed documents indicating value, has increased alarmingly and the quality of the counterfeits is unfortunately very high. Therefore, it is necessary to aim at developing solutions, by means of which a genuine product and its genuine package can easily be identified and distinguished from a counterfeit.

It is prior art to arrange luminescing particles in connection with the base web as, for example, granules reacting to light, which are mixed into paper pulp immediately prior to the headbox, as is disclosed in a solution in accordance with EP patent specification 226 367 B1. The granules can be mixed into the coating layer, too. The size of these clearly three-dimensional granules must be such, diameter more than about 30 μm, that they are visible for the human eye when illuminated with UV light. Since the commercially available luminescing pigments usually have a diameter of the order of 3 to 5 μm, it is necessary in the solution in accordance with EP 226 367 B1 to manufacture the granules mentioned above in a separate process from these small particles invisible for the human eye, which then will have a size that can be seen with the human eye. Granules of different colours may also be used to make the counterfeiting more difficult. In this solution, the luminescing granules form individual luminescing spots or spot build-ups, which are thus clearly visible and sharp-edged against their background when illuminated with UV light.

It is also known to arrange luminescing material sensitive to UV light on the surface of web-like material, for example, in the form of an even coating layer. There the luminescing material provides a clear and evenly luminescing total effect when exposed to UV light. Such an evenly luminescing coating layer is, however, relatively easy to counterfeit in view of printing technique by means of a so-called compact ink printing.

US publication 200310228447 illustrates on the other hand another solution, which aims at complicating counterfeiting of layered material by providing a mechanical depression, e.g. a logo or the likes on the base web, whereby the coating layers arranged on the base web form a layer at the depression, which is thicker than the layer in the surrounding area. If the coating layer on such a mechanical depression contains optical whiteners, the depressions placed at regular spaces are clearly seen in UV light, because those spots have more coating containing optical whitener. This creates a security structure resembling a watermark in the layered material. The thickness of the coating containing optical whitener is on other regions even and then locally at the depression greater. The coating containing optical whitener thus forms a regular pattern, when it is inspected in UV light. To counterfeit such a security factor positioned deep in the structure is difficult in view of the printing technique. Such mechanical depressions must, however, be manufactured by special rolls, which are extremely expensive and must be manufactured individually for each desired pattern. The alteration in the patterns or their relocation is thus not easily performed. Since we are discussing patterns to be generated by rolls, using this technique also directly results in a repeated, regular patterning, which has a predetermined, even amount of coating containing optical whitener E evenly distributed in the regions outside the depressions and a certain, greater amount of coating containing optical whitener on the depression.

It is also known, e.g. with banknote papers or the like, to include different fibres or particles optically reacting to UV light in the base web of the product, whereby the fibres or particles have been imported to the structure already when manufacturing the fiber furnish.

U.S. Pat. No. 6,632,773 publication again discloses a solution where in connection with the heat-sensitive recording material, luminescing material sensitive to UV light, is used on the reverse side of it. This luminescing material is preferably pyrene sulphonate-based. This material becomes visible in daylight too, when in gets into contact with alkaline liquid. The solution in accordance with the invention is intensified even more by adding water-soluble azine colour to the base web, which, when in contact with a suitable acid-solvent mixture, generates a visible colour reaction in the paper. An alternative disclosed in the publication, in which the luminescing material is brought onto the surface of the paper, or example, as irregular dot-like patterns (column 3, lines 11-14), corresponds to the same basic idea as disclosed already in the EP patent specification 226 367 B1 mentioned above. These dot-like patterns are clearly visible and sharp-edged against their background when illuminated with UV light.

The inventions mentioned above utilizing colour coatings sensitive to UV light have, however, certain disadvantages. When a particular security material, i.e. identification material sensitive to UV light, has been arranged on the outer surface or in the inner structure of the product, by one of the methods mentioned above, the luminescing effect becomes visible either as an even or a sharp-edged phenomenon, whereby it is possible to imitate such security solutions by printing machines and/or printer systems utilizing modern techniques. For example, the regular or irregular drop- or stripe-patterned coating on the outer surface of the material, the coating comprising identification material sensitive to UV light, mentioned in the U.S. Pat. No. 6,632,773 specification (column 3 lines 11-17 and column 4, lines 27-33) can very likely be imitated at least to a certain quality level, as far as printing techniques are concerned.

The above description illustrates a few solutions, the purpose of which is to provide products, the counterfeiting of which is as difficult as possible. It may, however, be possible to imitate these solutions by different printing machine and/or printer techniques. Moreover, some of these solutions are from the manufacturing point of view either expensive or inflexible.

A purpose of the present invention is to provide an improved layered structure, the counterfeiting of which is as difficult as possible or even impossible by conventional printing machine and printer techniques and at the same time, however, such a security structure, the identification of which may be performed easily, e.g. by UV light, without a need to utilize for example chemical agents. It is also a purpose of the present invention to provide a layered structure containing identification elements of different levels, some of which may be easily detected and others require special equipment and technique. A purpose of the present invention is also to provide a method of manufacturing layered material which is difficult to counterfeit, which method can be performed with web-like material, preferably in the manufacture of the material, by utilizing different known coating techniques. The solution in accordance with our invention can be applied to industrial production in a cost-effectively way.

A purpose of the solution in accordance with our invention is thus to facilitate the authenticity checking of for example a product package, sticker labels or wet glue applied labels, valuable papers, self-adhesive labels, or other products manufactured of layered material. The main characterizing elements of the layered structure and the method of manufacturing for such a layered structure in accordance with the present invention is disclosed in the accompanying claims.

A basic feature of paper making, the formation, caused during the manufacture of the layered material by the manufacture process itself in the generating base web, e.g. a fibre web formed by a paper machine, is described in connection with the present invention as follows as in publication: Pappersteknik, Christer Fellers, Bo Norman, KTH, Stockholm 1996:
formation is small scale variation in basis weight of the paper
the fibre distribution in the plane of the sheet determines the paper formation
physically the formation can be described by formula

F= [symbol] (w)/wm, in which

F=formation value [symbol]
(w)=BASIS WEIGHT DISTRIBUTION
wm=average basis weight.

When manufacturing web-like material by a paper, cardboard, or nonwoven machine, the web to be manufactured always has its typical formation. This formation is machine-specific and depends both on the operation parameters and the respective mechanical features of the machine. The formation value can be reduced by adjusting the process parameters and thus the formation can be improved. The formation is, however, a random phenomenon by nature and causes, e.g. the surface of the paper web to be topographically irregular.

Normally, when developing and improving the paper manufacturing process, the aim is to reach a formation value as small as possible, in other words as even local distribution of the basis weight as possible. A high formation value is thus a negative feature to a person skilled in the art of manufacturing paper and it is intentionally avoided, if possible. At the same time, the aim is to make all coating layers applied on the surface of the paper web as even as possible. This again enables realizing another typical wish of a person skilled in the art, i.e. reaching a uniform coverage of the coating layers.

With the present invention, it has been understood to accept the presence of certain features connected with the manufacture of paper, paperboard and nonwoven materials, which are conventionally considered negative. One of these features, the formation, is a random phenomenon and the other one, a by-product of this feature, the alteration in the thickness of the coating layers manufactured by blade coating technique, due to the coating technique itself; accepting these features is a conscious choice. By combining and modifying these features and the coating methods most practicable in each case, it is possible to produce paper, cardboard or nonwoven webs of very high standard in view of security.

In connection with the present invention the term coating layer of a layered material refers to the material layer, which is applied to a certain surface by adding a material on the surface, either as a non-continuous layer or as a continuous, i.e. substantially covering layer. A substantially non-continuous or substantially continuous coating layer may cover the whole web or only a part of it. If, for example, coating having the same composition is applied on a layered material from subsequent coating stations, this is considered to constitute two separate coating layers. A UV-dull type coating layer again refers to a coating layer, which does not contain optical whitener or identification agents. A UV-dull coating layer preferably contains, e.g. TiO2, which absorbs UV light. From now on the term UV-dull is used in connection with the present invention for the shortness-of the term. Identification elements of different levels are
overt—type, which refers to a security element continuously visible for the human eye,
covert—types which refers to a security element the detection of which requires an external apparatus, such as UV light or a simple chemical agent, which is easy to use, for example, only the us of water in the identification, and
forensic—type, which requires more sophisticated laboratory scale identification apparatus or processes.

The term contrast layer in connection with the present invention refers to a coating layer superposed on the base web, which is a part of the layered material, such as, for example, paper cardboard or nonwoven web, containing optical whitener or identification agent as a non-continuous coating layer, for example, as a random spot pattern, a stripe pattern, carried out by some known printing technique as a so-called logo or some other non-continuous pattern. Identification agents refer to luminescing agents other than optical whiteners, the manufacturing possibilities and availability of which are very limited and strictly supervised. The main function of the optical whiteners is to give the product in question a visually lighter appearance which is obtained when UV light hits the optical whitener and turns into visible light. The optical whiteners or identification agents used in connection with the contrast layer react to UV light. The optical whiteners are so-called basic chemicals in paper manufacture, so they are easily available for anyone. To be able to utilize the operational principle of the contrast layer in the best possible manner in view of security, a contrast agent is preferably chosen, the availability of which is very limited. The contrast layer in a solution in accordance with our invention is preferably formed of liquid material and is preferably able to partially penetrate the underlying structure or coating layer. The viscosity of the contrast layer is thus preferably substantially lower than what is usually used for example with conventional coatings for paper web. Therefore, the contrast layer may preferably be formed by a so-called spray coating technique or some other corresponding coating technique, in which the coating colour is applied to the surface to be coated by means of nozzle holes or similar dosing means within a distance from the surface to be coated. Other printing techniques can be used, as well, for forming the contrast layer. The contrast layer in accordance with our invention is preferably applied immediately on top of the base web. Our contrast layer thus has preferably substantially only two dimensions, i.e. the dimensions related to the shape of the non-continuous patterns mentioned, for example, spots or stripes. If particles have been used in the coating forming the contrast layer, their dimensions are so small that they are invisible for the human eye, whereby, for example, the spray coating technique mentioned above, or different printing techniques can be used in creating the contrast layer. These patterns of the contrast layer in accordance with our invention, thus have no substantial thickness, unlike, for example, the granules used in connection with the identification layer in accordance with the cited reference EP 226 367 B1. In the EP publication 226 367 B1, granules, in other words large three dimensional particles, 30-500 μm in diameter, have been used as the identification agent. In the invention in accordance with the EP publication 226 367 B1 these particles in the identification layer are thus intended to be visible for the human eye.;

The patterns forming the contrast layer contain optical whitener, for example, Tinopal ABP-Z (tradename) or actual identification agent and preferably a binder, e.g., CMC, starch, PVA or the like.

In an embodiment of our invention, the smallest dimensions, the length/the width of the non-continuous patterns, for example spots, so-called splash drop patterns, stripes, logos or similar patterns used in the contrast layer, are substantially such that they are visible for the human eye, in other words their smallest dimension is preferably at least the approximately 30 μm mentioned above. In the embodiment in accordance with our invention, the aim is to avoid a high number of small patterns, in other words, the occurrence of patterns that are smaller than what the human eye can perceive. Too small patterns of this kind, for example, unintentionally generated tiny splash drop patterns of aerosol spray, just cause a decrease in the effective function of the contrast layer because they decrease the contrast between the contrast patterns visible for the human eye and the background. There may be one or more of these contrast layers in the solution in accordance with the present invention. There may be contrast-causing materials of one or more colours in one and the same contrast layer. Materials creating contrast of different colours are preferably utilized in different contrast layers. Also, materials causing a contrast of similar colour may be utilized in one contrast layer or in different contrast layers, but in that case it must be ensured that the luminescence of the materials of the same color and optically active in UV light, or other colour intensity, is sufficient to bring about the desired contrast effect, when the layered material is exposed to UV light or similar. If the contrast layer containing droplet patterns is placed further out than the identification layer, at least one coating layer is preferably disposed on top of the contrast layer so as not to leave the contrast layer to serve as the outermost layer and thus liable to counterfeiting and, on the other hand, so as to provide such printing characteristics in the outer surface of the layered material that when using the desired printing methods the final print quality meets the required quality standards. In the embodiment in accordance with our invention, the contrast layer is preferably formed of liquid material, which partly penetrates the underlying material layer. Thus, an advantageous contrast layer in accordance with our invention does not have a substantial thickness, as it would have, if the contrast patterns were formed for example of granules visible for the human eye. The substantial non-existence of the thickness dimension of the contrast layer in accordance with our invention brings about the advantageous feature that it is easy to apply other coating layers by means of conventional on-line coating techniques on top of the contrast layer. Moreover, for example, the spray coating technique is a very useful and economical coating method.

In the present invention, the term identification layer relates to a coating layer containing an identification agent which reacts to UV light or the like. Identification agents refer to luminescing agents other than optical whiteners, the manufacture and availability of which is very limited and strictly supervised. The identification layer in accordance with our invention may be applied as the final outer surface of the product, on top of which, for example, the printings are provided. The identification layer is preferably on top of the contrast layer. The identification layer may be either immediately on top of the contrast layer or there may be one or more other coating layers between them. The solution in accordance with our invention can thus be used even as the outer surface, although we did criticsize the use of security elements in connection with the outer surfaces. This is because the manufacture of an irregular cloud-like identification layer in accordance with our invention for counterfeiting purposes is extremely difficult, if not impossible, as far as printing technique is concerned. However, one or more other UV-dull coating layer/layers is/are still preferably disposed on top of the identification layer, in order to optimize the printing characteristics of the outer surface. Thereby, the thickness of the identification agent layer containing expensive identification agent can be maintained optimal in view of the security features. The identification layer may, however, also be under the contrast layer and there can be one or more other coating layers between these layers.

The identification agent is typically either a luminescent or a phosphorescent agent. The identification layer containing identification agent may be formed by various known coating methods, which more or less efficiently follow the surface profile of the base web. Such coating methods are, for example, blade coating, rod coating or film transfer size press coating techniques. Each coating method mentioned above has a characteristic effect of its own, following the profile of the base web, on the profile of the coating layer to be formed. When choosing an appropriate coating method, for example one of the methods mentioned above, the profile of the coating layer can be chosen as desired taking the quality and the profile of the surface underneath into account. An inexpensive special solution, which must, however, have both the identification layer and the contrast layer, can be accomplished so that the contrast layer is formed of an identification agent by spray technique and the patterns of the contrast layer are thereby randomly distributed droplet patterns. In this special case, the identification layer can be formed of a less expensive optical whitener. If, on the other hand, a solution as sate as possible, yet more expensive, is desired, the contrast layer is formed by spray technique of an identification agent of a certain shade of colour and then the identification layer is formed of an identification agent of a different shade.

In a preferred solution in accordance with the invention, for example, at first two separate UV-dull coating layers are disposed by blade coating technique on top of a non-continuous contrast layer generated, for example, by spray technique, and the outermost identification layer is applied on top of the separate UV-dull coating layers also by blade coating technique, the printings being further applied onto the outermost identification layer. The identification layer containing identification agent is formed by such a coating method, for example, by blade coating technique, which by utilizing appropriate coating parameters produces a fully covering identification layer, the profile of which varies in thickness. Only such coating techniques can in this case be used, which produce a coating layer, in which very little, if any, coating containing identification agent remains in the local ridges of the formation and more coating containing identification agent remains in the local valleys of the formation. Thereby, the identification layer, when exposed to UV light, first of all has a cloud-like appearance because the thickness of the identification layer varies in different parts of the surface to be coated. In such a solution, the contrast layer is in fact and also visibly clearly beneath the identification layer. Depending on the local thickness of the identification layer and the two other coating layers, the patterns of the contrast layer as seen with the human eye vary in intensity, depending thus on the coverage of each of the local contrast patterns by the coating layers mentioned above. The coverage of these contrast patterns takes place substantially as a continuously sliding coverage, in other words, depending on the alterations in the thickness profile of the identification layer and other possible intermediary layers, the non-continuous patterns in the contrast layer beneath the identification layer mentioned and the other layers disappear or become more clearly visible to human eye. The visibility of the contrast patterns to the human eye on one hand as lying in the depth direction beneath the identification layer, and on the other hand with continuously sliding changes in the colour intensity and the cloud-like appearance of the identification layer makes the use of different counterfeiting techniques, especially those based on printing machines and/or printer techniques, in practice even impossible, because screening is required to bring about alternating luminescence intensity, which again can easily be detected, for example, by a magnifying glass.

The identification layer follows the profile of the base web and the other coating layers possibly disposed on top of it in such a way that by utilizing a suitable coating technique, such as blade coating, rod coating or film transfer size press coating technique, an identification layer with an altering thickness is generated. Thereby, a thinner identification layer is provided at the areas corresponding to the ridges of the base web than at the areas corresponding to the valleys of the base web.

For example, so-called contour coating techniques, such as air knife coating or curtain coating technique, will not come into question when forming an identification layer, because the coating with these techniques follows the formation of the surface to be coated in such a way that a uniform coating layer is formed. Thereby, it does not produce a cloud-like coating layer with an alternating thickness in accordance with our invention. A depression of watermark type disclosed in the prior art US publication 2003/0228447 A1 forms a clear and sharp interface to the identification layer applied on top of the depression. The layer of identification agent in the solution described in this publication is either of homogeneous thickness, or at some points, in other words at the mechanical depressions, the thickness is greater than the basic thickness, as already mentioned earlier.

The basic form of the cross-sectional profile of the base web in the solution in accordance with our invention remains substantially unchanged when disposing the contrast layer on the base web. This results in that the main features of the basic form in the cross-sectional profile of the base web remain also in the identification layer applied immediately onto the contrast layer or on top of some other coating layer on the contrast layer. When forming the contrast layer, the formation of the base web is intentionally followed. This may be carried out by producing the contrast layer, for example, by means of spray technique. The patterns of the contrast layer in accordance with our invention are, as mentioned already above, substantially two-dimensional, in other words their third dimension does not substantially arise from the surface, on top of which the contrast layer has been disposed. If a solution based on, for example, granules were utilized for forming a contrast layer, the patterns of the contrast layer would be significantly three-dimensional, because their size would have to be such that they would be visible for the human eye. This, again, would result in that the use of conventional coating methods used in paper coating, such as blade coating, rod coating or film transfer size press coating techniques would be very difficult, if not impossible. In the coating methods mentioned above, the metering of the coating film (the adjustment of the amount of coating) requires that the coating colour is free of granules like those described in the EP publication 226 367 B1. In order to be visible for the human eye, the luminescing granules should have such a size that they as such would cause problems in applying the coating techniques mentioned above. The particles present in the identification agents and optical whiteners used in the solutions in accordance with our invention are of such a small size that the blade coating, the rod coating or the transfer size press coating techniques mentioned above can be used without any difficulty.

Thus, the use of luminescing granules in the present solutions is limited to the wet end of a paper machine. If the luminescing effect can be brought about subsequent to the formation of the base web, as for example is the case of the solution in accordance with our invention, a very good result is achieved in view of the total economy. In the solution according to our invention, at least part of and preferably all the identification agents and/or optical whiteners creating the luminescing effect when reacting to UV light are provided in connection with the layered web-like material after the formation of the base web, in other words after a wire section or the like.

The contrast layer in a preferred embodiment of our invention is disposed either directly onto the base web, or one or more UV-dull layer/layers has/have been provided between these. Further, preferably one or more UV-dull layer/layers has/have been provided onto the contrast layer before forming the identification layer. This will emphasize the depth effect, which is created when the identification layer with different colour intensities continuously slidingly and partially covers the spot, stripe or other patterns of the contrast layer. This partial continuously sliding coverage of the contrast patterns can be intensified by applying one or more UV-dull layer/layers as depth layers between the contrast layer and the identification layer. The contrast layer in a preferred embodiment of our invention is applied beneath the identification layer, in other words closer to the base web. Such a security entity, formed in connection with the manufacturing process of paper, cardboard or nonwoven, preferably comprising an irregular cloud-like identification layer and a contrast layer beneath it with non-continuous patterns, the patterns being seen partially covered, is in practice very difficult if not impossible to counterfeit by printing methods. The manufacture of the solution of our invention requires in addition to a machine, e.g. a paper machine required for the manufacture of the web discussed, also a possibility to acquire the security agent or even different security agents, the availability of which is, as stated above, very limited. Moreover, the whole manufacturing process requires very skilled personnel.

Depending both on the thickness of the identification layer and on the thickness of the other coating layers on the base web, the identification layer in accordance with our invention is visible for the human eye in UV light as different non-continuous or cloud-like patterns. It is also possible to use identification agents sensitive to UV light, which reflect different colour, when UV light with different wavelength is directed to them. For example, colours based on pyrene sulphonite may react to 254 nm UV light as green colour, but to 360 nm UV light as blue. At the same time, the contrast layer containing non-continuous patterns provided under the identification layer becomes visible in UV light as patterns, the location of which the human eye sees clearly to be under the identification layer, in other words the contrast patterns are more or less clearly covered by the identification layer and possible intermediary layers on top of the contrast layer. Thus, a clearly stereoscopic image of the mutual location of the contrast patterns and the identification material is generated. Depending on the profile of the base web, the eye sees a thicker layer of coating on some of the contrast patterns and, correspondingly, a thinner layer of coating covering the other contrast patterns. There is, thus, a thicker layer of coating on the contrast patterns at the valleys and, correspondingly, a thinner layer of coating at the ridge areas. Therefore, the contrast patterns at the valleys are seen weaker in intensity and the contrast patterns at the ridges stronger in intensity. The security effect can be intensified even more by using several contrast layers showing contrast patterns of different colours or intensity. It is also possible to provide in connection with the base web, preferably therein, security elements reacting to UV light, which are known as such, for example fibers or particles, which further increase the security level of the so-called layered structure and increase even more the depth effect visible to the eye. The contrast layer can also be manufactured, for example, by means of printing technique, whereby so-called logo patterns, text, or the like signs, can be included therein.

When, for example, data of a label is printed on the surface of such a layered material containing different security components, a printed product is produced, the authencity of which can easily be stated, for example in shops, stock admission and customs checkpoints by means of UV detectors already generally in use. By utilizing the solution of our invention, it is easy to identify merely by means of UV light whether the product to be checked and its security components have been manufactured in connection with the manufacture and coating process of the paper or some other web itself, whereby the visible three-dimensional depth effect described above in the mutual relation between the contrast patterns and the identification layer is either achieved or not. An attempt to counterfeit by means of a printing machine technique is revealed in that the contrast patterns seem in UV light clearly “two-dimensional”, in other words the dept effect generated when the identification layer and the contrast layer are manufactured as multilayer coating, is missing, in other words the covering effect of the contrast pattern in accordance with our invention is not generated. The existence of screen features relating to printing machine and printer techniques further make the identification of a counterfeit easier.

The layered material in accordance with our invention preferably contains at least one forensic-type identification agent in the base web 1 or in some other coating layer, such as in surface sizing, in one of the coating colours used or in combinations of these, the identification of the identification agent being carried out by a special method and/or in special conditions, such as in a laboratory.

The solution in accordance with the invention will be described with reference to the accompanying drawings, which illustrate a few embodiments of the invention; however, it is not an intention to limit the invention to these embodiments.

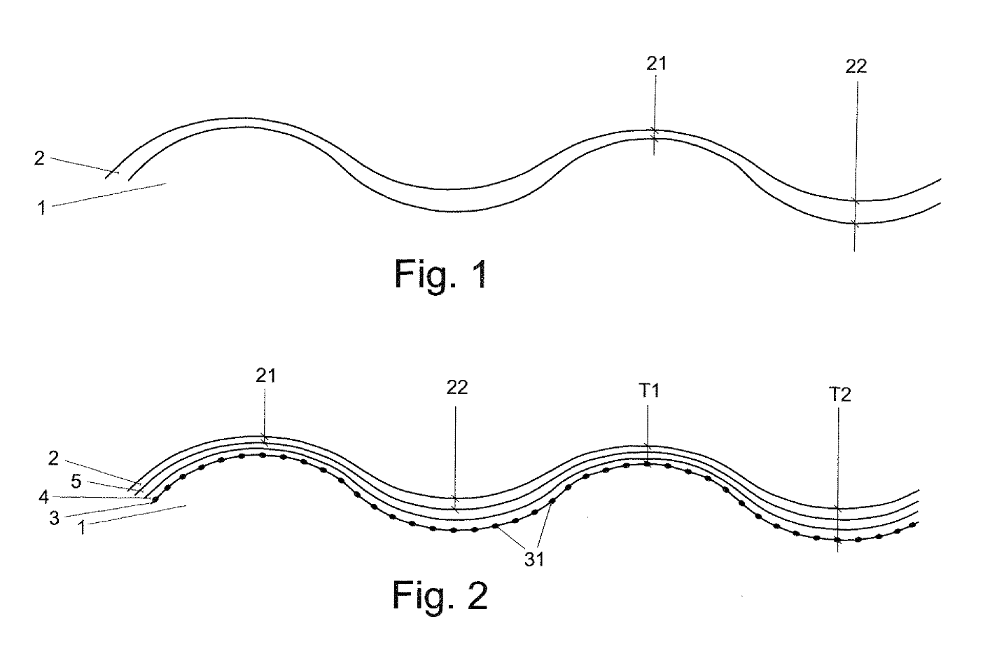

FIG. 1 illustrates in a simplified schematic view the profile of a coating layer containing identification agent, forming the outermost coating layer and having been applied onto the base web serving as the base paper, by strongly exaggerating the height differences in the profile of the base web and the identification layer; and

FIG. 2 illustrates another embodiment of the invention illustrating the use of several coating layers.

The solution in accordance with FIG. 1 does not illustrate other coating layers on a base web 1, which possibly have been applied underneath an identification layer 2. The base web, in this particular example the base paper, has its own typical alterations in the cross-sectional profile, which are machine-specific and depend on the operation parameters. These differences in the cross-sectional profile of the base paper have intentionally been exaggerated in these exemplary drawings. In this embodiment in accordance with the basic solution of our invention, the identification layer 2 forms the outermost coating layer, on top of which for example the printings are disposed. Thus, identification agent reacting to UV light has been provided in the coating colour forming the outermost pigment layer. The thickness of the identification layer is smaller at point 21 of the cross-sectional profile of the layered structure, i.e. at the ridge area of the identification layer 2, than that at the valley area 22 of the identification layer 2. Due to this difference in the thickness of the coating layer containing the identification agent, the appearance of the identification layer 2 is cloud-like in UV light. The valley areas 22 are seen as more luminescing and the ridge areas 21 as less luminescing areas. The coating can be so thin at the ridge areas that the luminescence is hardly visible in the UV light. The changes in the luminescence rate between the valley areas 22 and the ridge areas 21 take place gradually, smoothly, without any radical changes in the luminescence rate. The basic solution in accordance with our invention for ensuring the product security is thereby based on the use of a cloud-like coating containing identification agent and covering the entire surface, which coating randomly varies in thickness according to the local formation. When, for example, a blade in the blade coating technique touches locally a ridge area of the profile of any of the underlying layers, only very little coating containing identification agent remains at this point. Correspondingly, substantially more coating containing identification agent remains in the valley area. Thereby, the amount of the identification agent at different areas of the surface to be coated randomly varies from about zero at the ridge areas to full luminescence at the valley areas. The thickness of the identification layer is in the solution of our invention so thin that due to the coating performed by means of an appropriate coating technique, such as for example blade-coating technique, great relative differences in the thickness and thus in the coverage are intentionally generated. Thereby, the coverage differences due to the differences in the thickness of the identification layer become clearly visible as strong alterations in the intensity of the luminescence phenomenon, when exposed to UV light.

The solution in accordance with FIG. 2 illustrates another embodiment of our invention, in which security elements have been added to the embodiment of FIG. 1, by applying first a contrast layer 3 on top of the base web, and two depth layers 4 and 5 thereon. This drawing also illustrates the special areas 21 and 22 illustrating the thickness differences in the cross-sectional profiles of the identification layer 2, described also in connection with FIG. 1. The contrast layer 3 has been formed by means of a spray coating technique on top of the base web 1. The contrast layer 3 is thus formed of contrast spots 31, which have been distributed on the cross section surface either totally irregularly or, if so desired, they can be arranged to form greater entities consisting of the contrast spots 31, for example, stripes. If the contrast layer 3 is formed, e.g. by a printing machine technique, the contrast patterns form regular patterns of the desired configuration. The smallest dimensions, the length/the width of these contrast spots 31 or other non-continuous contrast patterns, for example, so-called splash patterns, stripes logos or the like, are substantially such that they are visible for the human eye, in other words their smallest dimension is preferably for example above 30 μm or more. When this layered material is exposed to UV light, the contrast patterns 31 at the valley areas of the cross section of the structure show less intensity at points T2, where the thickness of the total coating layer on top of the contrast layer is great. At the same time, at these valley areas of the formation also the thickness of the identification layer is locally greater and thus the layer is more intensely luminescing. The contrast patterns 31 located at the ridge areas of the cross section of the structure correspondingly are shown more intensely, because at these points T1 the thickness of the total coating layer on the contrast patterns 31 is less than at points T2. The changes between the valley areas T2 and the ridge areas T1 from the less visible areas, i.e. from the contrast patterns located deeper in the coating structure, to the more visible areas at the ridges, i.e. to the contrast patterns located slightly closer to the surface, take place gradually, smoothly, without any radical changes in the luminescence. At the same time, the thickness of the identification layer is locally smaller at the ridge areas, sometimes even almost non-existent and thus less luminescing or sometimes locally even almost non-luminescing.

The solution according to our invention, for example, for the manufacture of a structure based on layered paper/nonwoven, can be brought about advantageously and easily, for example, by a paper machine/nonwoven machine, whereby after forming the web serving as the base web, coating layers reacting to UV light in accordance with the present invention are applied on top of it. At least some of the coating layers reacting to UV light, for example, the contrast layer, is preferably produced by spray coating technique. Thereafter, for example, by utilizing blade coating technique, a first and thereafter a second UV-dull coating layer is applied to serve as depth layers, in other words to bring to the total structure as much distance as possible between a contrast layer and an identification layer, i.e. as much three-dimensional effect as possible and, at the same time, partial covering effect of the contrast layer. Further, by utilizing blade coating technique, an identification layer is applied on top of the two depth layers. The identification agent reacting to UV light is thus a part of the outermost coating layer, the rest of the constituents of which are otherwise chosen so as to produce good characteristics to the surface of the coating layer in view of the subsequent printing process. Thus, the identification layer can be on the outer surface, on which the desired printings are later applied. Then it naturally contains in addition to the identification agent itself also all the other pigments and fillers necessary in a printable outer surface. Where necessary, the identification layer can be provided as a separate coating layer and the final outermost coating layer, onto which the printings are applied, can be applied onto it. Thereby, the thickness of the identification layer may be adjusted as operationally desired, not too thin but not too thick, either. Thus, excessive use of the expensive identification agent is avoided. The final coating layer, on which the printings are then made, can again be formed such that its thickness and composition meet the requirements of that particular printing process. One or more of the coating layers can be applied also by a separate coating machine.

As already stated earlier in connection with FIGS. 1 and 2, the intensity alterations in the identification layer in the solution of our invention substantially follow the formation of the base web and therefore they take place randomly and smoothly. Thus, our identification layer does not have any sharp edges in the patterns. A feature typical of the printing machine techniques generally used by counterfeiters, which the identification layer of the solution of our invention does not have, is the screen pattern surface. If the aim is to bring about the cloud-like luminescing appearance visible in UV light of the identification layer and the luminescing partial and smooth coverage of the contrast patterns by means of a printing technique, it is necessary, even with the ink jet technique, to always use some kind of print dot formation or halftone screening to create said continuously fading effect. By utilizing simple solutions of the covert technique, in addition to the UV light also a conventional magnifying glass, it can be identified, whether a certain pattern has been produced by a printing machine method, i.e., whether the surface of the picture is screened or not.

The present invention is described more in detail with reference to a few of its preferred embodiments. Our invention may widely be applied anywhere, where the authenticity of products or their parts, which themselves are layered materials and on the surface of which text or graphics may be printed, if so desired. It is also possible to utilize our invention, where layered materials may be used in connection with the product itself, e.g., as a package or as, for example, self-adhesive labels or wet glue applied labels on the product itself or other layered printing products to be applied to the product. The invention has been described above with reference to some of its preferred embodiments, only. As is evident to a person skilled in the art, many alternative and optional structures and modifications are possible within the scope of inventive idea defined in the appended claims.

1. A method of manufacturing a layered web-like material, the web-like material comprising a base web (1), of for example paper, cardboard, or nonwoven and this web-like material containing identification agent reacting to UV light or the like, characterized in that at least one identification layer (2) is applied on the base web (1), the identification layer following the surface profile of the base web (1) and of the other coating layers possibly disposed on top of the base web in such a way that an identification layer (2) with an altering thickness is intentionally produced, for example, by means of blade coating, rod coating or coating transfer size press coating technique, whereby the coating layer at the areas of the identification layer (2) corresponding to the ridges of the base layer (1) is applied to be thinner than that at the areas corresponding to the valleys of the base layer (1), and the identification layer (2) advantageously covering the entire underlying surface of paper, cardboard, or nonwoven web, and the identification layer (2) being non-continuous in intensity, when reacting to UV light, due to the alterations in the thickness of the coating layer, causing a cloud-like appearance.

2. A method in accordance with claim 1, characterized in that at least one two-dimensional, non-continuous coating layer containing an optical whitener, a contrasting luminescing identification agent or the like, in other words a so-called contrast layer (3), is supplied on the web-like base web (1) for example as a random spot pattern, a striped pattern, a so-called logo or some other non-continuous pattern produced by a known printing technique.

3. A method in accordance with claim 2, characterized in that applied on the web-like base web (1), at least two non-continuous layers, contrast layers (3), containing a contrasting luminescing identification agent or an optical whitener, for example, as a random spot pattern, a striped pattern, as a so-called logo or some other non-continuous pattern produced by a suitable printing technique, in such a way that the contrast layers are either immediately one on top of the other or that there is at least one further coating layer between them and that one or more coating layers is/are applied at least on the outermost contrast layer, at least one of layers, the so-called identification layer (2), containing luminescing identification agent, and the layer/layers having been coated by utilizing such a coating technique that the thickness profile of the coating follows the surface profile of the base web (1) and of the other coating layers possibly applied on top of it, the identification layer (2) preferably covering the whole underlying surface area and the coating layer containing an identification agent being non-continuous in intensity when reacting to UV light or the like, thus causing a cloud-like appearance.

4. A method in accordance with claim 2, characterized in that the contrast layer (3) is preferably coated by spray coating technique or the like.

5. A method in accordance with claim 2, characterized in that at least two spray coating units or the like are used when forming the contrast layer (3), whereby contrast patterns of different colours or shapes or contrast patterns of similar colour but of different intensities or thicknesses are produced.

6. A method in accordance with claim 1, characterized in that blade coating, rod coating or film transfer size press coating technique is used in forming at least one coating layer.

7. A method in accordance with claim 2, characterized in that preferably the coating layers other than the contrast layer (3) have been formed, for example, by a so-called blade coating technique, or by some other known paper coating technique following the formation of a paper web, which brings about thickness alterations in the coating layer.

8. A method in accordance with claim 2, characterized in that the forming of the web-like material and coating it with the contrast layer (3), the identification layer (2) and the other coating layers being required before printing, takes place in connection with the manufacture of the web.

9. A method in accordance with claim 1, characterized in that at least one of the coating processes of the web-like material is performed by a separate coating machine.

10. A method in accordance with claim 1, characterized in that identification agent creating a luminescing effect when reacting to UV light is applied to the layered web-like material after the basic web formation, in other words for example in a paper machine subsequent to the headbox.

11. A method in accordance with claim 1, characterized in that the identification agents and/or optical whiteners creating a luminescing effect when reacting to UV light are applied to the layered web-like material after the basic web formation, in other words for example in a paper machine subsequent to the headbox.
